(19) United States
(12) Patent Application Publication
(10) Pub. No.: US 2014/0234042 A1
(43) Pub. Date: Aug. 21, 2014

(54) Driving Device For Exerting A Translatory And Rotary Motion On A Drive Shaft For Driving A Deburring Tool And Method For The Operation Thereof

(71) Applicant: Heule Werkzeug AG, Balgach (CH)

(72) Inventor: Roman Faessler, Marbach (CH)

(73) Assignee: HEULE WERKZEUG AG, Balgach (CH)

(21) Appl. No.: 14/162,431

(22) Filed: Jan. 23, 2014

(30) Foreign Application Priority Data
Feb. 16, 2013 (DE) 10 2013 002 727.6

(51) Int. Cl. B23B 51/10

(52) U.S. Cl. CPC B23B 51/101
USPC 408/1 R; 408/161

(57) ABSTRACT

Method for operating a driving device for exerting a translatory and rotatory motion on a drive shaft (1) for driving a deburring tool (29), wherein the at least one deburring blade (32) of the deburring tool (29) performs a continual indexing (=stepwise advancing) rotatory motion along the bore margin (45) and at the same time a lifting motion along the bore margin (45), lifting motion which is oriented in the direction of the bore longitudinal axis.

The invention relates to a driving device for exerting a translatory and rotatory motion on a drive shaft for driving a deburring tool for deburring or more generally: for machining circular or noncircular bore margins in any workpieces, as well as to a method for operating such a driving device.

Deburring tools are used for deburring bore margins, wherein the through bore is machined both on the inlet-side and also on the outlet-side bore margin. The term “deburring” generally refers to machining a bore margin, although it is not necessary, for the purpose of the invention, to remove burrs that may be present on the bore margin. A machining of the bore margins of a simple bore hole and/or a through bore can also take place in that other cutting machining processes are carried out on the bore margin, for example, in order to produce peripherally extending knock-outs, recesses, grooves and the like.

The subject matter of the invention accordingly is a driving device for exerting a translatory and rotatory motion on a drive shaft for driving a deburring tool having at least one cutting deburring blade.

In DE 37 12 458 A1, rolling bodies are arranged in several grooves and they can be engaged in sheaths which can be rotated toward one another. Such a feed gear and transmission is also described in DE 860 130 A, for example.

In DE 38 40 974 A1, an oscillatory motion of a drive shaft is performed via an inclinable axle.

In DD 267 914 A1, DE 39 18 400 A1 or U.S. Pat. No. 2,566,571 A1, oscillatory motions are produced by means of grooves that are mutually offset on the periphery of a tool.

However, all the known arrangements share the disadvantage that they have a complicated structure, are subject to a high degree of Wear and are incapable of performing rapid movements.

Therefore, the invention aims to further develop a driving device for exerting a translatory and superposed rotary motion on a drive shaft in such a manner that the drive shaft, at high machining force and high machining speed, is capable of guiding a deburring tool on the bore margin of a bore to be debarred.

To achieve the indicated aim, the invention is characterized by the technical teaching of Claim 1.

Thus, when the term “deburring tool” is used in the following description, it should be understood merely as an example, because, within the context of the present invention, the important feature is the driving device which drives the machining tool, and which performs a translatory motion and, superposed on the translatory motion, a rotatory motion.

The deburring blade of this deburring tool performs a continual indexing (=stepwise advancing) rotatory motion along the bore margin. At the same time, a lifting motion occurs along the bore margin, which is oriented in the direction of the bore longitudinal axis.

By means of the deburring tool, using at least one deburring blade or another cutting tool, a rotatory motion oscillating along the bore margin with simultaneous lifting motion is carried out.

It is a feature of the invention that, in a drive shaft driven in rotation, a central guide bore aligned in the axial direction is arranged, in which a cam body, which is guided so that it is axially movable, can be shifted, in that at least one pin engages in a sinusoidal drive cam arranged peripherally on the cam body, pin which is arranged radially in the guide bore of the drive shaft, in that furthermore the cam body is rotatably connected to a shaft in the axial direction, wherein on the outer periphery of said shaft at least two grooves are arranged on the periphery with mutual offset, wherein one groove is configured as an axially oriented straight groove and the other groove is an oblique groove oriented at an angle to the axial line, and in that in each case a radially inwardly directed pin-shaped tappet engages with positive connection in each groove, tappet which is connected to the inner ring of a ring-shaped radial freewheel enclosing the shaft, wherein two radial freewheels arranged one above the other and mutually connected rotatably on their outer periphery are present, whose outer periphery is connected rotatably, and in that the shaft of the cam body is lengthened in the form of a tool holder in which the deburring tool can be held.

The result of this technical teaching is the considerably simpler structure of a driving device in comparison to the prior art, particularly in comparison to DE 37 12 458 A1, which indeed also generates a lifting motion from a rotatory motion, but which lacks an oscillating, step-wise indexing motion in the circular direction on the bore margin.

Therefore, the present invention is characterized in that a lifting motion is generated from a rotatory motion in a manner which in itself is known, but, in addition, on said lifting motion, a step-wise advancing motion of the deburring blade along the bore margin is superposed, which succeeds in producing according to the invention a particularly simple, operationally reliable and low-wear driving device.

Thus, tests have shown that such a driving device can be operated with rpm values in the range from 300 to 1000 rotations per minute, and that, with a deburring tool attached thereto, a lift of 10 to 50 mm can be produced.

The indexing steps can be dimensioned in the step range from 1/500 mm to 1 mm.

The motion according to the invention of the driving device for the deburring tool is characterized in particular in that, if the deburring of a through bore is directed toward the rear, first an outward directed translatory motion occurs in the axial direction out of the bore, in particular by a distance to the point that with simultaneous rotation, the deburring tool approaches the bore margin in a cutting mode and removes any burrs present there.

Due to the return lifting motion, on which at the same time a rotary motion is superposed, a motion of the deburring blade oriented substantially obliquely in the direction toward the bore longitudinal axis occurs.

The purpose of the rotatory motion is for the deburring blade to carry out the deburring process during the return stroke (in the direction into the bore), and for it to be located after the completion of the rotatory motion in another portion of the bore margin, after which an additional advance of the deburring blade out of the bore then occurs and during the return stroke the rotation takes place again, as a result of which an adjoining site of the bore margin that follows is then deburred.

The invention is characterized in that very few moving parts are present. The characterizing feature here is that an axially movable cam body is connected rotatably to the drive shaft, which has only on its outer periphery a sinusoidal drive can extending over 360 degrees on the periphery, in which, with positive connection, at least one radial pin engages, which is arranged on the inner periphery of the guide bore of the drive shaft, and thus controls the motion of the cam body.

The present invention is characterized furthermore in that the cam body is connected rotatably to the adjoining shaft in which grooves that are open to the outside and directed toward one another are arranged, distributed on the periphery—preferably offset by 180 degrees—, wherein one groove is configured as a straight groove and the other groove as an oblique groove.

The invention is not limited to an arrangement wherein the oblique groove and the straight groove are mutually offset by 180 degrees on the periphery of the shaft of the cam body. In another embodiment, it is possible to provide for the grooves to be arranged with a mutual offset of only 90 degrees on the outer periphery of the shaft.

A radially oriented tappet, which is attached to the inner ring of a radial freewheel, engages in the respective groove.

The term radial freewheel denotes a rotationally symmetrical ring-shaped body configured like a ball bearing, which consists of an inner ring carrying the tappet, wherein, on the outer periphery of said inner ring, in the area of a gap, clamping bodies are arranged in an arrangement with even distribution on the periphery, and they bear, on their the outer periphery, with frictional connection, against the inner periphery of an outer ring. The outer periphery of the outer ring is rotatably connected to the machine.

As a result of this type of design of the radial freewheel, it is ensured that the inner ring, relative to the outer ring which is kept stationary, can rotate in only one particular direction of rotation, while the opposite direction of rotation is blocked.

The inner ring is connected on its inner periphery to the radially inwardly directed pin, which is designed as a tappet, which engages with positive connection either in the straight groove or—in the case of the other radial freewheel—in the oblique groove.

The two radial freewheels have exactly the same design, so that, for the purpose of the description, it is sufficient to describe only the structure and the configuration of a single radial run.

The blocking effect in one direction of rotation is characteristic for the two radial freewheels, while, in the other direction of rotation, the radial freewheel unblocks the rotation of the shaft of the cam body. The two radial freewheels block the rotation in the same direction of rotation and they unblock the rotation in the other direction of rotation.

The combination of the above-mentioned means produces the desired lifting and rotatory motion of the shaft of the cam body, wherein the rotatory motion occurs only in indexing steps from, for example, 1 angular degree with an indexed advance of the debarring blade on the bore margin in: the direction of rotation from approximately 1/500 to 1 mm. As a result of the value of the inclination of the oblique groove in the direction toward the vertical, the width of the indexing step is predetermined.

The inventive subject matter of the invention results not only from the subject matter of the individual claims, but also from the combination of the individual claims with one another.

All the indications and features disclosed in the documents, including the abstract, in particular the spatial design represented in the drawings, are claimed as essential to the invention, to the extent that they are novel individually or in combination in comparison to the prior art.

The invention is explained below in reference to drawings that represent only one embodiment in further detail. Here, additional features and advantages of the invention which are essential for the invention can be obtained from the drawings and their description.

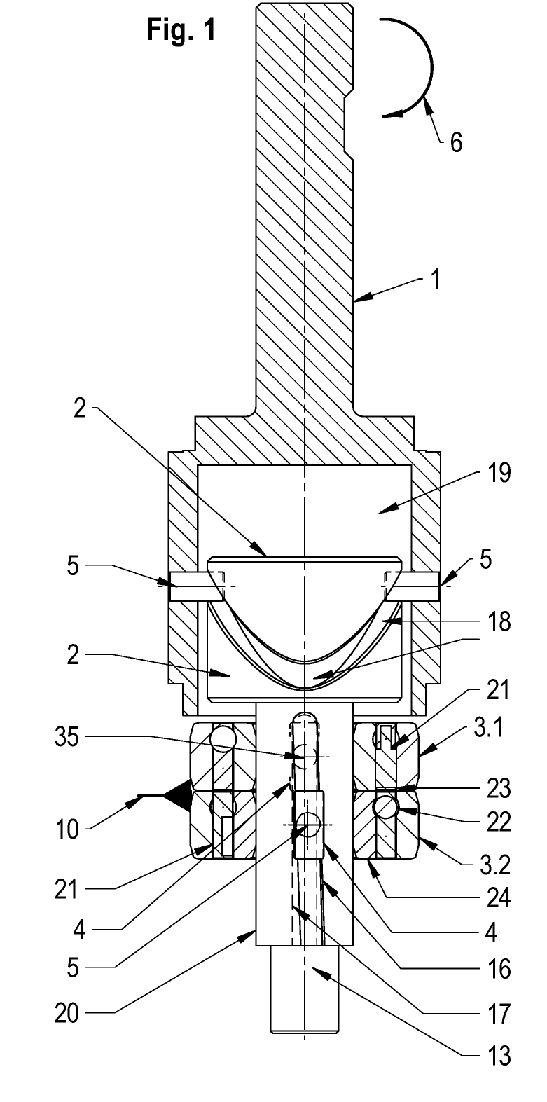

FIG. 1 shows: a longitudinal section through a driving device according to the invention

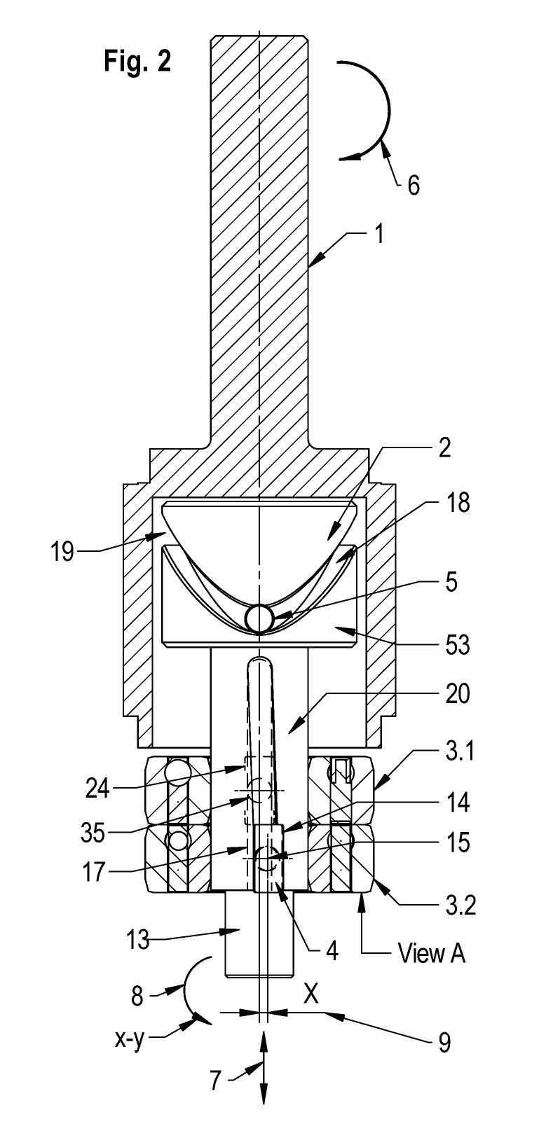

FIG. 2 shows: the same longitudinal section through the driving device according to FIG. 1 with a cutting plane offset by 90 degrees

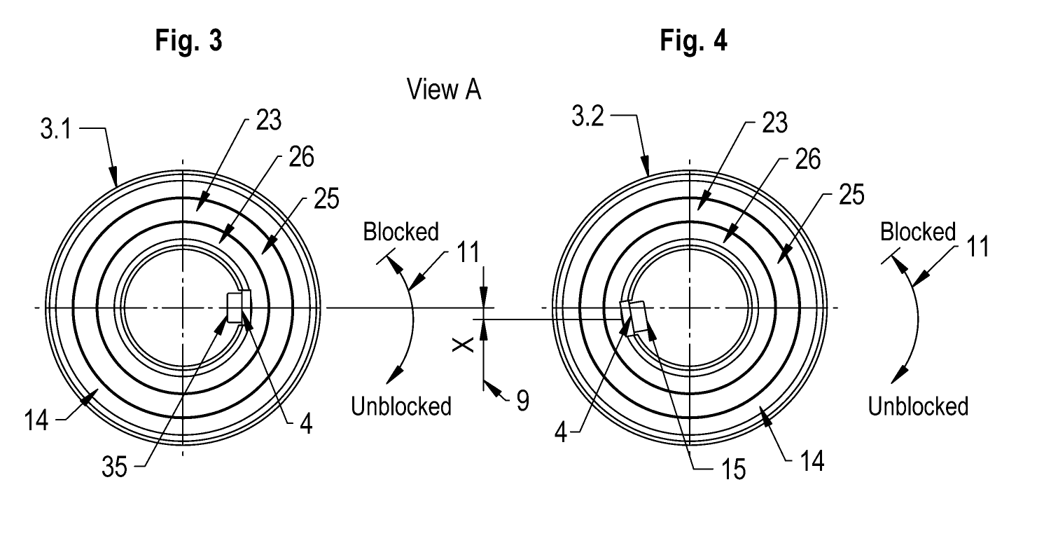

FIG. 3 shows: the top view of the upper radial freewheel

FIG. 4 shows: the top view of the lower radial freewheel

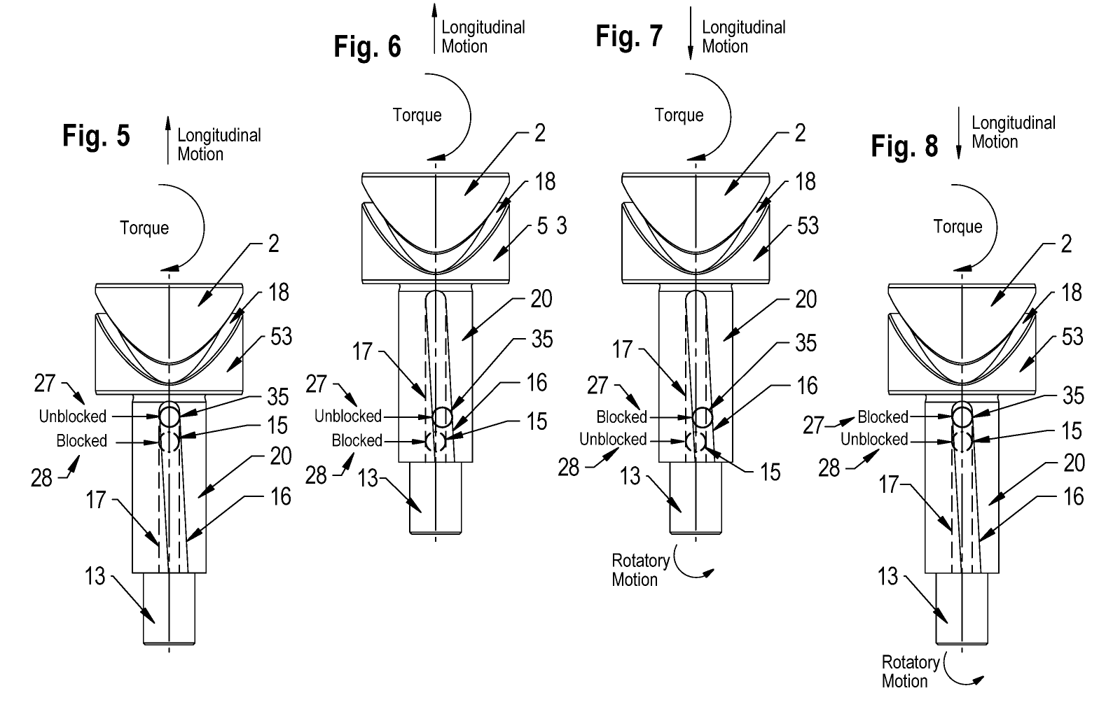

FIG. 5 shows: a diagrammatic representation in a side view of a motion course with engagement of the bolts of the tappet as desired in the oblique groove and in the straight groove in the first motion stage

FIG. 6 shows: the second motion following FIG. 5

FIG. 7 shows: the third motion following FIG. 6

FIG. 8 shows: the fourth motion following FIG. 7

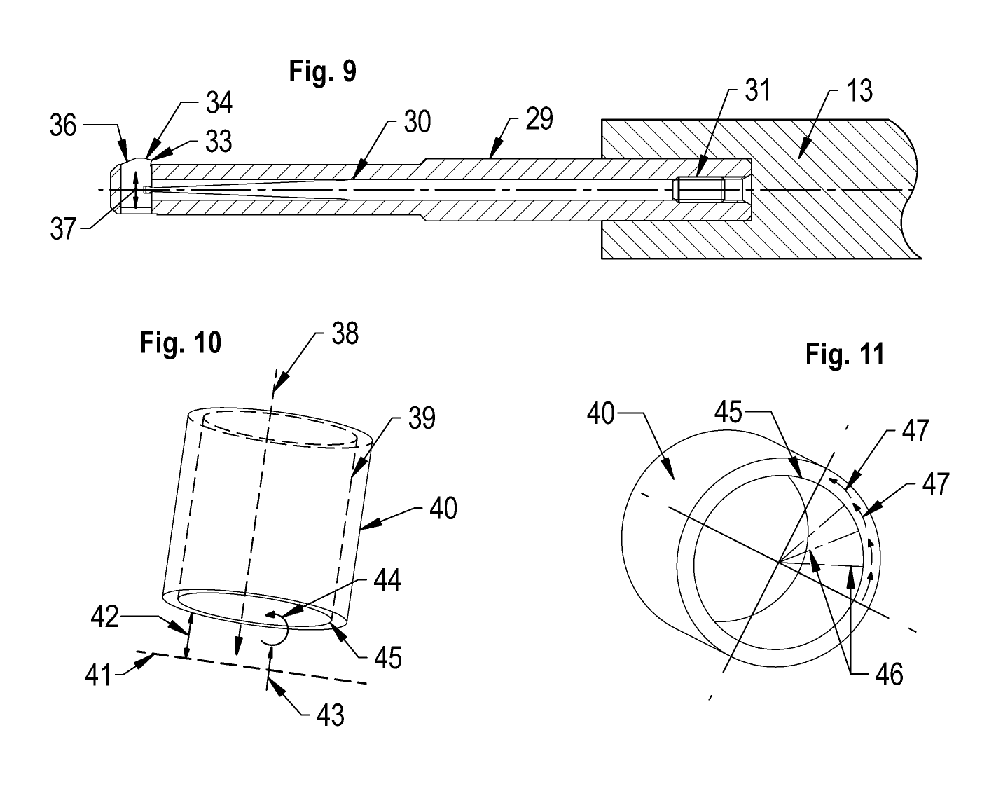

FIG. 9 shows: a longitudinal section through a deburring tool as clamped in the tool holder of the driving device

FIG. 10 shows: a diagrammatic motion process during the deburring of a bore margin of a through bore

FIG. 11 shows: an enlarged view, shown diagrammatically, of the deburring of the bore margin according to FIG. 10

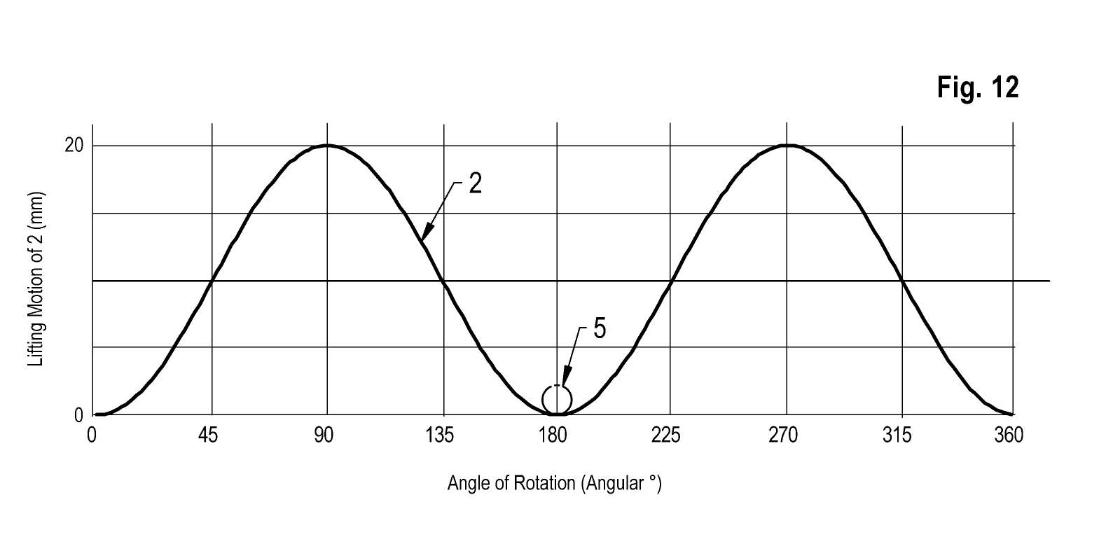

FIG. 12 shows: the drive cam of the cam body 2, unrolled onto the plane

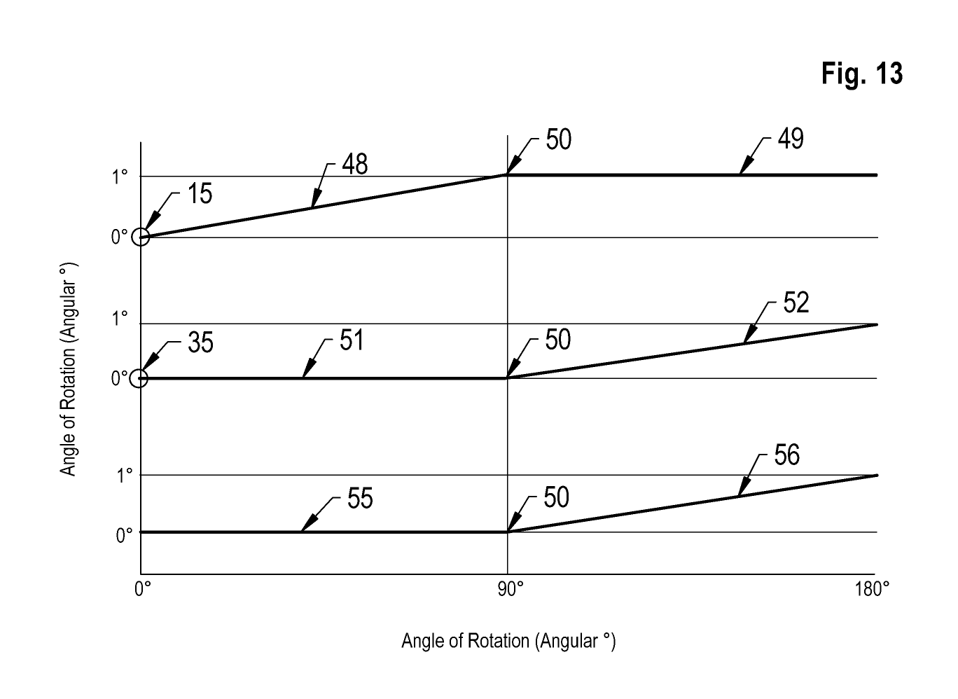

FIG. 13 shows: the shifting motions of the tappets with the bolts arranged there, through the angle of rotation of the drive shaft

The drive shaft 1 is inserted, in a manner not represented in further detail, in the chuck of a driving machine driven in rotation, and it is driven in rotation in arrow direction 6, for example.

The drive shaft 1 broadens in the shape of a cylindrical body which forms a cylindrical guide bore 19 configured to be open downward at the front side.

In the internal space of the guide bore 19, a cam body 2 is arranged, which consists essentially of a cylindrical upper portion, in the outer periphery of which a sinusoidal drive cam extending over the entire periphery extends, which is closed on itself over the periphery, and which is shown in FIG. 12 in an unrolled representation.

The drive cam 18 is configured as a recessed groove machined over the periphery of the cam body 2 and open outwardly. Into the drive cam 18, pins 5 that are mutually offset by an angle of 180 degrees engage; they are attached to the cylinder body 54 of the drive shaft 1 and engage with their radially inwardly directed ends with positive connection on different sides in the drive cam 18.

In this manner, the cam body 2 is held in a manner so it can be shifted in the axial direction and rotated in the cylinder body 54 of the drive shaft 1, and it is continued downward with a shaft 20 rotatably attached thereto, which itself is rotatably connected to a tool holder 13, which receives the deburring tool 29 represented only as an example in FIG. 9.

On the outer periphery of the shaft 20, two radial freewheels 3.1 and 3.2 that are arranged one above the other and configured as ring bodies are arranged.

Each radial freewheel 3.1 and 3.2 has the same design, and the function is explained in further detail in reference to FIGS. 3 and 4.

Since the parts of the two radial freewheels 3.1 and 3.2 have exactly the same design, the same reference numerals are also used.

In each case, an inner ring 26 carries a bolt 15, 35 protruding radially into the internal space of the radial freewheel 3.1 and 3.2, wherein each bolt 15, 35 is part of a tappet 4, 24.

The result of this is that each bolt 5, 35 is connected in each case to a tappet 4, 24, and each tappet is mounted with positive connection in an associated groove 16, 17 on the outer periphery of the shaft 20 in a manner so that it can be shifted.

The two grooves 16, 17 are machined on the periphery into the outer periphery of the shaft 20 with mutual offset. In the depicted embodiment example, the two grooves 16, 17 are mutually offset by an angle of 180 degrees.

One groove 16 is configured as an oblique groove whose longitudinal extent forms an angle with respect to the rotation axis or the vertical of the entire drive shaft 1, while the other groove is configured as a straight groove 17 so that its longitudinal extent extends parallel to the longitudinal direction of the drive shaft 1.

The pins 15, 35 are part of the tappets 4, 24. On the outer periphery of the inner ring 26, a sealing ring 23 is arranged, which forms at its outer periphery an annular space 25 in which clamping bodies 21 or alternatively spherical bodies 22 are arranged evenly distributed on the periphery.

The outer ring 14 follows radially outwardly the clamping or spherical bodies 21, 22 arranged in the annular space 25. Thus, the respective radial freewheel 3.1 and 3.2 consists of the mentioned rings 23, 26, 14 and the clamping 21 and spherical bodies 22 located in between.

According to the representation in FIGS. 3 and 4, the respective radial freewheel 3.1 and 3.2 in one direction of rotation (in arrow direction 11) allows a clockwise rotation in arrow direction 11, while in the case of the counterclockwise rotation in arrow direction 11′, a blocking takes place, that is to say the clamping bodies 21 prevent a relative turning of the inner ring 26 with respect to the outer ring 14.

The step width 9 (delta X) is the step width by which in each case the outer ring 14 can be turned with respect to the inner ring 26.

Accordingly, the tool holder 13 performs an oscillating lifting motion in the arrow directions 7 (in the Z axis), while at the same time a rotatory motion in arrow direction 8 in the X-Y plane by in each case the step angle 9 (delta X) occurs.

This is achieved by the juxtaposition of the oblique groove 16 in relation to the straight groove 17 and the tappets 4, 24 arranged there in each case in a manner so they can be shifted.

This driving principle is described further in reference to FIGS. 5 to 8.

To simplify the representation, only the cam body 2 is shown, which comprises an upper portion that transitions into a cylindrical section 53 into whose outer periphery the sinusoidal outwardly open drive cam 18 is machined.

The cylindrical section 53 is followed by the shaft 20 forming a single part made of one material. In the shaft 20, the straight groove 17 (on one side) and the oblique groove 16 (on the other side) are arranged with a mutual offset of 180 degrees in the circumferential angle.

Since in the drawing, from the front, the oblique groove 16 can be seen, it is drawn with solid lines, while the straight groove 17 located on the rear side is drawn with broken lines.

At the same time it is shown that the bolt 15—in a manner which is not visible—engages in the straight groove 17, while the visibly drawn bolt 35 engages in the oblique groove 16. The two bolts are represented in a raised position near the arrows 27, 28.

In the case of the rotation of the drive shaft 1, which is not shown in further detail, relative to the cam body which is held stationary, in the transition from FIG. 5 to FIG. 6, the cam body 2 is shifted according to FIG. 6 upward, wherein at the same time the tool holder 13 is shifted upward in arrow direction 7 as a result. As a result, the two bolts 15, 35 migrate in the associated grooves 16, 17 downward, as represented near the arrows 27, 28. The situation in the respective freewheel is represented with the arrows 27 and 28.

One can see that the bolt 35, which is part of the tappet 24, is unblocked, and thus performs a shifting motion in the direction of the oblique groove 16, while the other bolt 15 is blocked, and as a result the rotatory motion of the cam body 2 is stopped and therefore a longitudinal motion caused by the drive cam 18 occurs. No indexed rotatory motion has yet taken place. This indexed rotatory motion does not take place before the transition from FIG. 6 to FIG. 7.

There one can see that the bolt 35 is now blocked with its radial freewheel near arrow 27, and the bolt 15 which can be shifted in the straight groove 17 is unblocked by its radial freewheel. As a result of the downward motion of the cam body 2 in the cylinder body 54 of the drive shaft 1, an indexed rotatory motion as recorded in FIG. 7 is performed in arrow direction 8 on the tool holder 13.

At the time of the transition from FIG. 7 to FIG. 8, the same process as in FIG. 5 is carried out, that is to say when the drive shaft continues to rotate in relation to the cam body 2 which is held stationary, the latter is again shifted entirely downward and the process according to FIG. 5 starts again.

The deburring tool 29 is represented only as a possible embodiment example in FIG. 9. It can be replaced by any desired other type of debarring tool. For example, it is not necessary that, at the front end of the debarring tool 9—in a so-called measurement window—, a radially outwardly directed debarring blade 32 is present, which is spring-pretensioned with a flexible spring 30 oriented in the longitudinal direction, and which is clamped into a central inner bore of the debarring tool 29.

The flexible spring 30 is held at the rear end by a clamping screw 31, and the front end of the flexible spring 30 engages on one side in the debarring blade 32, which accordingly is radially oriented in the measurement window in the arrow directions 37 and configured so that it can be shifted under a spring load.

The deburring blade 32 has a cutting edge 33 on the rearward side for application against the bore margin and for the machining treatment of the bore margin 45. The cutting edge 33 is followed by a noncutting guide surface 34 which is closed off toward the front by a noncutting entry surface 36.

Accordingly, the debarring tool 29 can be moved in arrow direction 38 into a bore 39 of a workpiece 40, and then, in the first process step according to FIG. 5, moved out of the bore in the arrow direction included in the drawing, in particular to position 41 which forms a gap 42 with respect to the debarred bore margin 45, so that the deburring blade 32 with its cutting edge 33 is moved entirely out of the bore.

During the return stroke, that is to say in arrow direction 43, the debarring blade 32 is applied with its cutting edge 33 in a cutting mode to the outer periphery of the bore margin 45, and during this return stroke it performs an indexed (stepwise advancing) rotatory motion in arrow direction 44. This corresponds to the motion course according to FIGS. 6 and 7.

In this manner, the deburring blade 32 deburrs only a small segment on the periphery of the bore margin, as represented in FIG. 11. The individual segments are separated from one another by segment lines 46, wherein the distance between the segment lines can be approximately 1/500 of a millimeter to 1 mm.

The bore margin is accordingly deburred successively in the arrow directions 47 in each case during the return stroke with simultaneously superposed rotation.

FIG. 12 shows, in relation to a rotation angle from 0 to 360 degrees, the unrolling of the drive cam 18 onto the paper plane of the drawing. There one can see that the mutually facing pins 5, which are integrated radially inwardly fn the cylinder body 54 of the drive shaft 1, perform an oscillating lifting motion, in particular depending on the rotation angle of the drive shaft 1 with respect to the cam body 2 which is held stationary. The length of the stroke can be in the range from 10 to 50 mm.

FIG. 13 shows the movement curve of the bolts 15, 35, which are part of the tappets 4, 24. The bolt 15 first executes, proceeding from the rotation angle 0 degree of the cam body, a curve 48 directed obliquely upward. This is the path which is traveled by the bolt in the oblique groove 16 and which at the same time ensures a rotation of the cam body 2 by the indexing angle delta X (reference numeral 9).

In the case of a rotation angle of 180 degrees and position 50, the oblique curve 48 transitions into a straight curve 49, with which no rotatory shift occurs any longer.

This applies analogously to the bolt 35 which moves along in the curve 51. From rotation angle 0 to 180 degrees, no rotatory shift occurs, while from position 50, the movement is through the obliquely extending curve 52, as a result of which an indexed rotatory motion by the step width delta X between the cam body 2 and the drive shaft 1 occurs again.

The invention is not limited to the radial freewheels 3.1 and 3.2 working with radially outwardly directed spherical bodies 22 and clamping bodies 21. In another embodiment which is not represented further, it is possible to provide that the radial freewheels 3.1 and 3.2 do not work with radially outwardly directed bodies 21, 22; instead these bodies are arranged one above the other in axial planes. Instead of a radially outwardly staggered arrangement, an axially mutually superposed arrangement of balls and clamping bodies 21, 22 can also be used.

In a third embodiment, it is possible to provide that the radial freewheels 3.1 and 3.2 are replaced by a ratchet mechanism. In the case of such known components as well, it is always ensured that the rotation motion is unblocked in a particular rotation direction, while the rotation motion in the opposite rotation direction is blocked.

The two radial freewheels 3.1 and 3.2 are incorporated with the same effect one above the other, wherein one bolt, for example, the bolt 15, engages in the oblique groove 16, while the other bolt 35, for example, engages in the straight groove 17.

During operation, the rotating drive shaft 1 with the cylinder body 54 connected thereto encloses the cam body 2, which is held stationary, and which is oscillatingly raised and lowered by the engagement of the pins 5, which are attached on the inner periphery of the rotating cylinder body, in the drive cam 18 on the outer periphery of the cam body. After the cam body 2 has been connected to the shaft 20 and the latter carries at its lower end the tool holder 13 for the deburring tool 29, the deburring tool with its deburring blade 32 also carries out the rapid lifting motions directed in the axial direction in the arrow directions 7.

The axial guiding of the cam body 2 in the arrow directions 7 is achieved by the passage of the shaft 20 of the cam body 2 through the two machine-fixed radial freewheels 3.1 and 3.2. Each inner ring 26 of each radial freewheel 3.1 and 3.2 is connected to a tappet 4 whose bolt 15, 35 engages in each case in a groove 16, 17 in the shaft 20 of the cam body 2.

The rotation of the shaft 20 of the cam body 2 generated by 1 angular degree per stroke, for example, is achieved by the axial shifting of the bolts 15, 35 in the two grooves 16, 17. Because one groove is designed as an oblique groove 16, the shaft 20 during each stroke is rotated by a certain, always constant, angular degree in a rotation direction, since one bolt 35 of the tappet 4 engages in the oblique groove 16 and the other bolt 15 of the other tappet 4 engages in the straight groove 17 on the outer periphery of the shaft 20. Each bolt 15, 35 is connected to a tappet 4 and it is attached to the respective inner ring 26 of in each case one radial freewheel 3.1 and 3.2.

### LIST OF REFERENCE NUMERALS

1 Drive shaft

2 Cam body

3.1 Radial freewheel 1

3.2 Radial freewheel 2

4 Tappet

5 Pin

6 Arrow direction

7 Arrow direction

8 Arrow direction

9 Delta X

10 Torque support

11 Arrow direction

12

13 Tool holder

14 Outer ring

15 Bolt (straight groove 17)

16 Oblique groove

17 Straight groove

18 Drive cam

19 Guide bore

20 Shaft

21 Clamping body

22 Spherical body

23 Sealing ring

24 Tappet

25 Annular space

26 Inner ring

27 Arrow

28 Arrow

29 Deburring tool

30 Flexible spring

31 Clamping screw

32 Deburring blade

33 Cutting edge

34 Guide surface

35 Bolt (oblique groove 16)

36 Entry surface

37 Arrow direction

38 Arrow direction

39 Bore

40 Workpiece

41 Position

42 Gap

43 Arrow direction

44 Arrow direction

45 Bore margin

46 Segment line

47 Arrow direction

48 Curve

49 Curve

50 Position

51 Curve

52 Curve

53 Cylinder section

54 Cylinder body

1. Method for the operation of a driving device for exerting a translatory and rotatory motion on a drive shaft (1) for driving a deburring tool (29), characterized in that the least one deburring blade (32) of the deburring tool (29) performs a continual indexing (=stepwise advancing) rotatory motion along the bore margin (45) and at the same time a lifting motion along the bore margin (45), lifting motion which is oriented in the direction of the bore longitudinal axis.

2. Method according to claim 2, characterized in that, in the case of a rearwardly oriented deburring of the bore margin (45) of a through bore, first the deburring blade (32) is shifted in the axial direction entirely of the bore (39) (outward translatory motion (39)) and in that during the subsequent return stroke the deburring blade (32) is rotated by 1 angular degree, for example, and during the return stroke, with simultaneous rotation, the deburring blade (32) is brought closer in a cutting mode to the bore margin and there removes any burrs present.

3. Method according to one of claims 1 to 3, characterized in that, as a result of the return lifting motion, which is superposed at the same time by a rotatory motion, a motion of the deburring blade (32) oriented obliquely in the direction toward the bore longitudinal axis occurs.

4. Driving device for exerting a translatory and rotatory motion on a drive shaft (1) for driving a deburring tool (29) for deburring bore margins (45), characterized in that, in a drive shaft (1) driven in rotation, a central guide bore (19) oriented in the axial direction is arranged, in which an axially movable cam body (2) can be shifted, in that at least one pin (5), which is attached radially in the guide bore (19) of the drive shaft (11), engages in a drive cam (18) whose unrolled pattern is approximately sinusoidal and which is arranged peripherally on the cam body (2) on the outer periphery, in that the cam body (2) is connected in the axial direction rotatably to a shaft (20) holding the deburring tool (29), wherein, on the outer periphery of said shaft, at least two grooves (16, 17) are arranged on the periphery with mutual offset, in that in each case one radially inwardly directed tappet (4) guided in a longitudinally shiftable manner in the groove (16, 17) engages with bolts (15, 35) in each groove (16, 17) with positive connection, and each bolt (15, 35) in each case is connected to the inner ring (26) of in each case one cylindrical radial freewheel (3.1; 3.2) enclosing the shaft (20), wherein the outer surface of the freewheel in each case is attached rotatably and in a machine-fixed manner.

5. Driving device according to claim 4, characterized in that one groove is configured as an axially oriented straight groove (17) and the other groove is configured as an oblique groove (16) oriented at an angle with respect to the axial line, into which groove in each case one pin-shaped tappet (4) with bolts (15, 35), which is connected to the inner ring (26) of the radial freewheel (3.1, 3.2), engages with positive connection.

6. Driving device according to one of claims 4 and 5, characterized in that the two mutually superposed radial freewheels (3.1, 3.2), which are interconnected rotatably and in a machine-fixed manner at their outer periphery, are each rotatably connected by their inner ring to the shaft (20).

7. Driving device according to one of claims 4 and 5, characterized in that the inner ring (26) of the radial freewheel (3.1, 3.2), relative to the outer ring (14) which is held stationary, rotates only in a certain direction of rotation, while the opposite direction of rotation is blocked.

8. Driving device according to one of claims 4 to 7, characterized in that the radial freewheel (3.1, 3.2) consists of a rotationally symmetrical ring-shaped body, configured as a ball bearing, which consists of an inner ring (26) supporting the tappet (4) with the bolts 15, 35, wherein, at the outer periphery of said inner ring, in the area of an annular space (25), clamping bodies are arranged with even distribution on the periphery, which at their outer periphery are applied in one direction of rotation with blocking effect and in the other direction of rotation in a manner so they run freely on the inner periphery of a machine-fixed outer ring (14).

9. Driving device according to one of claims 4 to 8, characterized in that the respective inner ring (26) of the radial freewheel (3.1, 3.2) supports on its inner periphery the radially inwardly directed bolt (15, 35) of the tappet (4), which engages with positive connection either in the straight groove (17) or—in the case of the other radial freewheel (3.1, 3.2)—in the oblique groove (16).

10. Driving device according to one of claims 4 to 9, characterized in that, on the outer periphery of the inner ring (26), a sealing ring (23) is arranged, which, on its outer periphery, forms an annular space (25) in which clamping bodies (21) or spherical bodies (22) are optionally arranged evenly distributed on the periphery.
